(19) United States
(12) Patent Application Publication
(10) Pub. No.: US 2008/0067795 A1
(43) Pub. Date: Mar. 20, 2008

(54) Safety Arrangement Comprising an Inflatable Element and a Method of Inflating an Inflatable Element

(75) Inventors: Mats Johansson, Fristad (SE); Peter Qvint, Vargarda (SE); Mats Karlin, Vargarda (SE)

Correspondence Address: HARNESS, DICKEY & PIERCE, P.L.C., P.O. BOX 828, BLOOMFIELD HILLS, MI, 48303, US

(73) Assignee: AUTOLIV DEVELOPMANT AB, Vargarda (SE)

(21) Appl. No.: 11/632,245

(22) PCT Filed: Jun. 15, 2005
(86) PCT No.: PCT/SE05/00907

§ 371 Date: Feb. 1, 2007

(30) Foreign Application Priority Data
Jul. 13, 2004 (GB) 0415670.9

(51) Int. Cl. B60R 21/26

(52) U.S. Cl. 280/736

(57) ABSTRACT

A safety arrangement comprising: an inflatable element (1); an inflator to provide a combustible gas to the interior of the inflatable element to inflate the inflatable element at least partially; a flexible member (3) having first and second portions which are respectively connected to first and second attachment sites (4,5), at least one attachment site being on the inflatable element (1), and an igniter (9) connected to the flexible member on inflation of the inflatable element, the distance between the first and second attachment sites increases and when the distance between the first and second portions of the flexible member exceeds a predetermined distance, the igniter is ignited (9), thus igniting the combustible gas within the inflatable element.

### DESCRIPTION OF INVENTION

THIS INVENTION relates to a safety arrangement, and in particular concerns a safety arrangement including an inflatable element, such an air-bag, which may be inflated within a vehicle upon detection of a crash situation, to minimize the risk of injury to an occupant of the vehicle.

It is well known to provide one or more inflatable elements, such as air-bags, within a vehicle. Upon detection of a crash situation, the air-bag is inflated and expands into a region between an occupant of the vehicle and an object, such as the steering wheel or instrument panel of the vehicle, against which the vehicle occupant might otherwise be flung by forces arising from the crash.

It has previously been proposed to provide an air-bag which is, during an initial inflation stage thereof, partially filled with a combustible gas or mixture of gases, and subsequently to ignite the gas or mixture of gases to inflate the air-bag fully. An air-bag of this type is disclosed in International Patent publication No. WO 98/26960.

This document further discloses the provision of one or more flexible wires, each of which is fixed to an inner wall of the air-bag at one end and attached to a respective actuator at the other end. The arrangement is such that, if the air-bag inflates beyond a predetermined size the actuators are activated when the flexible wires are detached from their respective actuators, resulting in the transmission of an electrical impulse to a control device, which in turn transmits an activation signal to an ignition device, to ignite the gas or gases within the air-bag and inflate the air-bag fully.

However, if the inflation of the air-bag during the initial inflation phase is impeded, for instance by the presence of a seat occupant or a child seat, the air-bag will not inflate to a sufficient size for the flexible wires to detach from their respective actuators during the initial inflation phase, and so the actuators will not be activated. Thus, the ignition device will not be activated, and the combustible gas or gases used to inflate the air-bag during the initial inflation phase will not be ignited. This minimizes the risk of a vehicle occupant being injured by the air-bag.

It is an object of the present invention to seek to provide a simplified ignition method for an air-bag of the type described above.

Accordingly, one aspect of the present invention provides a safety arrangement comprising an inflatable element; an inflator to provide a gas to the interior of the inflatable element to inflate the inflatable element at least partially; and a flexible member having first and second portions which are respectively connected to first and second attachment sites, at least one attachment site being on the inflatable element, wherein there is an igniter connected to the inflatable member and the gas is a combustible gas, the arrangement being such that on inflation of the inflatable element, the distance between the first and second attachment sites increases; and when the distance between the first and second portions of the flexible member exceeds a predetermined distance, the igniter is ignited, thus igniting the combustible gas within the inflatable element.

Advantageously the flexible member is arranged so that, prior to inflation of the inflatable element, two regions thereof are adjacent one another, and so that, during inflation of the inflatable element, the two regions there of are separated, and the igniter is arranged so that separation of the two regions of the flexible member causes activation of the igniter.

Preferably, a pull element is connected between one of the two regions and the igniter, and the igniter is arranged so that pulling of the pull element from the igniter causes activation of the igniter.

Conveniently, two pull elements are provided, connecting respective ones of the two regions with the igniter.

Advantageously, prior to inflation of the inflatable element, the flexible member is configured to contain a loop so that the two regions thereof are adjacent, and a retaining arrangement is provided to hold the loop in place prior to inflation.

Preferably the retaining arrangement comprises strings, sheets or bands.

Conveniently the safety arrangement comprises two or more flexible members.

Advantageously, a pair of flexible members are provided, each of which is attached to respective pull elements of the igniter and to respective regions of the inflatable element, and wherein the igniter is arranged so that pulling of at least one of the pull elements from the igniter causes activation of the igniter.

Preferably, the flexible member is provided substantially within the inflatable element.

In one embodiment, the first and second attachment sites comprise respective portions of the inflatable element.

In an alternative embodiment, one of the attachment sites comprises a portion of the inflatable element, and the other of the connection sites comprises a part of the igniter.

Conveniently, the igniter is configured to activate upon pulling of the flexible member from the igniter.

Advantageously, the igniter comprises a pull igniter.

Preferably, the combustible gas comprises a mixture of gases.

Another aspect of the present invention provides a method of inflating an inflatable element, the method comprising the steps of providing an inflatable element; providing an inflator for providing a gas to the interior of the inflatable element to inflate the inflatable element at least partially; providing a flexible member having first and second portions, and connecting the first and second portions to first and second attachment sites, at least one of the attachment sites being on the inflatable element and the arrangement being such that, during a first inflation phase of the inflatable element, the distance between the first and second attachment sites increases wherein the method comprises connecting an igniter to the flexible member generating combustible gas from the inflator to at least partially inflate the inflatable element, and when the distance between the first and second portions of the flexible member exceeds a predetermined distance, igniting the igniter and thus igniting the combustible gas within the inflatable element.

In order that the present invention may be more readily understood, embodiments thereof will now be describe, by way of example, with reference to the accompanying drawings, in which:

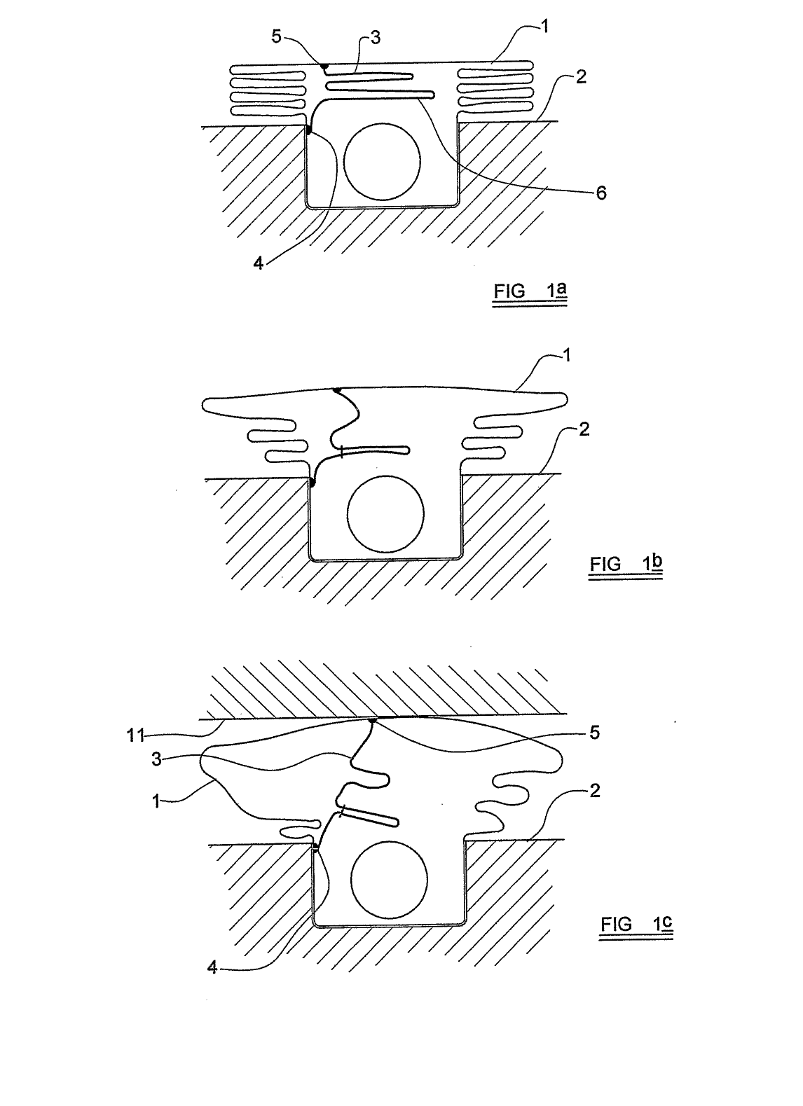

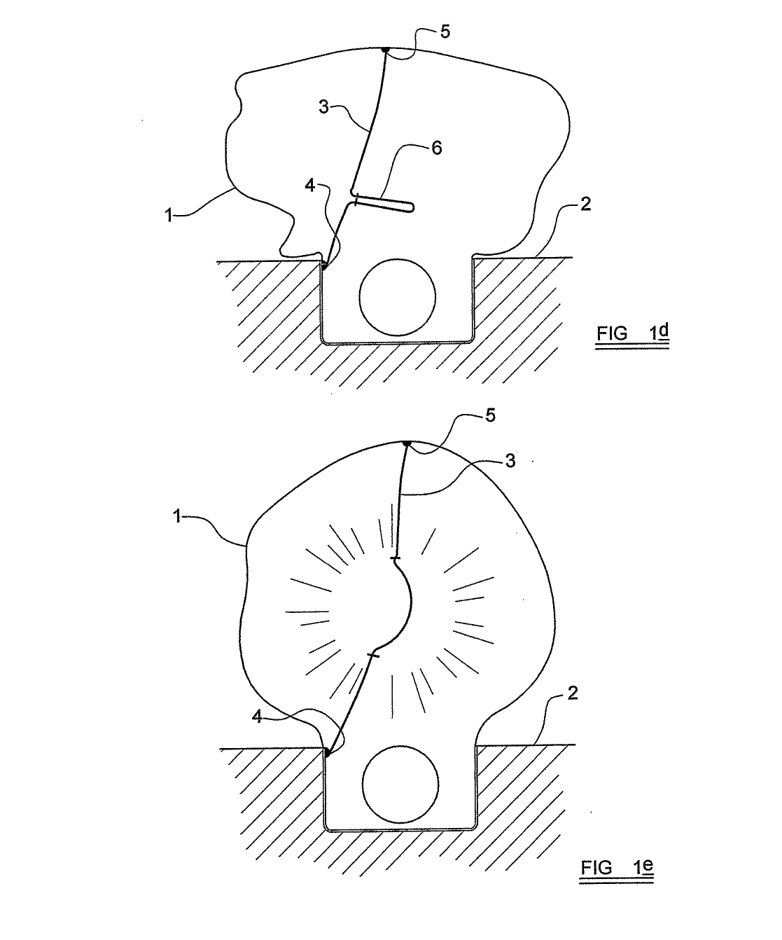

FIGS. 1a to 1f show stages in the deployment of a safety system embodying the present invention;

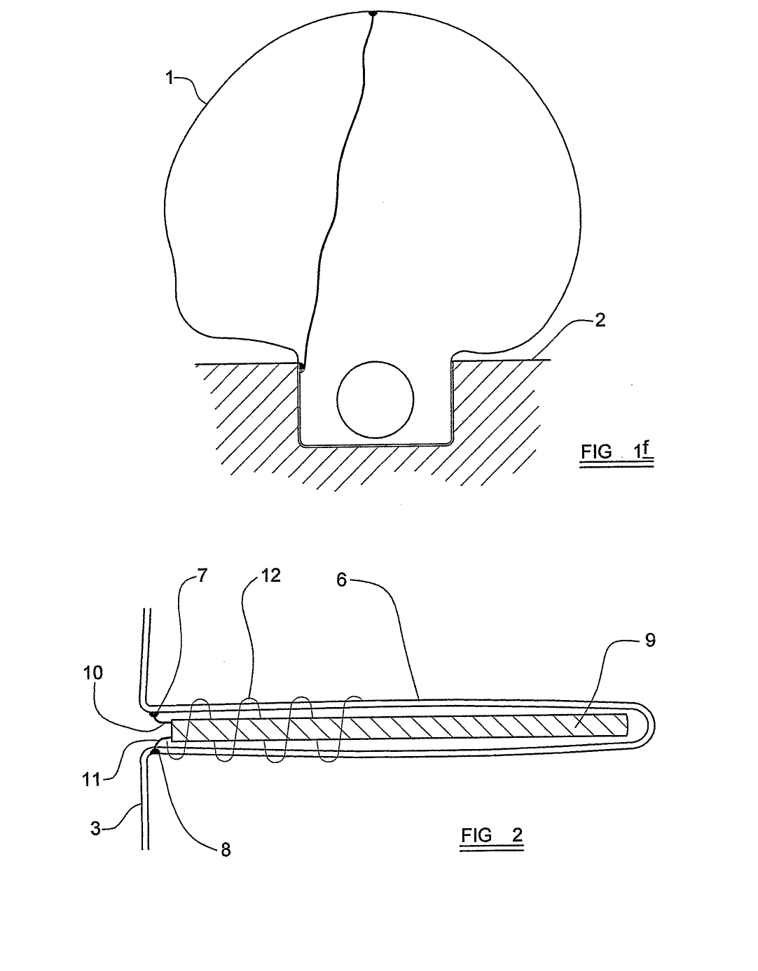

FIG. 2 shows further detail of the safety system of FIG. 1; and

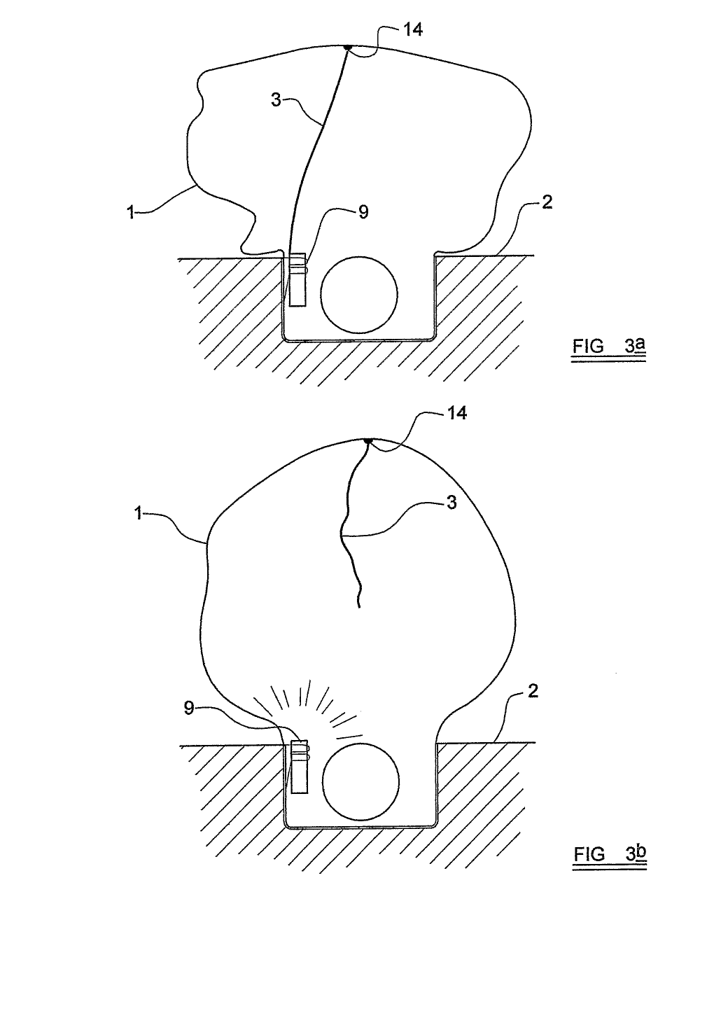

FIGS. 3a and 3b show stages in the deployment of a further safety system embodying the present invention.

Referring firstly to FIG. 1a, an inflatable element, in the form of an air-bag 1, is shown. The air-bag 1 is mounted on a surface 2, and the surface 2 may be, for instance, a central portion of a steering wheel, a part of a dashboard, or a portion of a vehicle seat.

In an initial, uninflated state, the air-bag 1 is folded tightly, so as to occupy a minimal amount of space in the vehicle. The air-bag has an inflator to provide combustible gas to the interior of the inflatable element to commence inflation of the inflatable element, and thus to inflate the inflatable element at least partially. A flexible member, for instance comprising a strip 3 of sturdy, flexible material, is attached between a first location 4 and a second location 5 on an interior surface of the air-bag 1. The first location 4 is near the rear surface of the air-bag, that is, a portion of the air-bag 1 that is close to the surface 2 from which the air-bag 1 expands. The second location 5 is provided on a front portion of the air-bag 1 so that, when the air-bag 1 is inflated, the second location 5 is on the far side of the air-bag 1 from the portion thereof which remains attached to the surface 2. The flexible member need not comprise a strip of material, and indeed may take any form that allows the flexible member to be tightly packed within the uninflated air-bag 1 and subsequently to extend as the air-bag 1 inflates. For instance the flexible member may comprise a plurality of interconnected, rigid elements, in a chain-like formation.

The strip 3 of material is configured to have a loop 6 therein, prior to inflation of the air-bag 1. Referring to FIG. 2, more details of the loop 6 in the strip 3 of material are shown. Due to the presence of the loop 6, two regions 7, 8 of the strip 3 of material are brought near to one another. Within the loop 6, which is defined by the region of the strip 3 of material between the first and second portions 7, 8 thereof, there is provided an igniter 9, which is preferably elongate in shape.

Two pull elements, such as short cables 10, 11, extend from the regions 7, 8 of the strip 3 of material that are brought near to one another by the formation of the loop 6, and are connected to the igniter 9. In preferred embodiments of the invention the igniter is configured to activate when either of the cables 10, 11 are pulled therefrom. In preferred embodiments of the invention, the igniter 9 is a “pull igniter”, an example of which is disclosed in U.S. Pat. No. 5,313,888.

A pull igniter may, for example, comprise an approximately tubular body having a pyrotechnic composition mixture packed into one portion of the body and a central passageway passing therethrough. An igniter cup is positioned within the end of the central tube, and a pull wire extends through the central passageway and protrudes from the body so that a user can grasp the pull wire. The igniter cup is partially filled with an igniter mixture, and the pull wire extends through the igniter cup, with an end of the pull wire being coated with a scratch material. An exposed end of the pyrotechnic composition is covered with an easily ignitable primer material, and the outer end of the tubular body is covered with a sealant, coating or membrane to seal the body with a device against moisture or of a contaminants. When the pull wire is pulled firmly by a user, the friction generated by the passage of the scratch material through the igniter cup causes the igniter mixture to ignite, and this in turn ignites the primer material, and ultimately the pyrotechnic composition mixture. There are, however, many other ways in which a pull igniter may be constructed, and these will be readily apparent to a person who is skilled in the art. Activation of the igniter 9 will result in the combustion of combustible gas or gases in the region of the igniter 9.

Alternatively, only one the igniter 9 may be configured to activate when a selected one of the cables 10, 11 is pulled therefrom. In these embodiments, the other of the cables 10, 11 does not serve the function of a pull element, but is attached to the strip 3 of material and to the igniter 9 to ensure that the selected one of the cables 10, 11 is pulled from the igniter 9 if the looped configuration of the strip 3 of material is broken.

A retaining arrangement, comprising lengths 12 of string, wire, sheets or bands, or similar flexible material are wrapped around the loop 6, to maintain the configuration of the loop 6 and to ensure that the igniter 9 remains within the loop 6 prior to inflation of the air-bag 1. In alternative embodiments of the invention, sheets or bands may be used in place of the lengths 10 of string, and a skilled person will readily appreciate how this would be achieved. The robustness of the retaining arrangement, which may be determined, for example, by the number of lengths of string which are wrapped around the loop 6, determines the force which is required to disturb the looped configuration of the strip 3 of material. This will be described in greater detail below.

A safety system embodying the present invention is preferably equipped with one or more crash sensors, to detect a crash situation in which the air-bag 1 should be inflated. Crash sensors suitable for use with the present invention include, but are not limited to, accelerometers and impact sensors.

When one or more of the crash sensors determines that the air-bag 1 should be inflated, an initial stage of inflation begins. During this initial stage of inflation, one or more combustible gases are introduced rapidly into the interior of the air-bag 1, causing the air-bag 1 to inflate partially. FIG. 1b shows the air-bag 1 beginning to inflate during this initial stage of inflation. In preferred embodiments of the invention, two separate gas-tight containers, such as bottles, are provided to introduce combustible gases into the interior of the air-bag 1 during the initial stage of inflation. One of the these gas-tight containers contains a fuel gas, such as methane or propane, and the other of the gas-tight containers contain an oxidizer gas, such as oxygen. One or more inert gases may also be provided in one or more of the gas-tight containers. During the initial phase of inflation of the air-bag 1, the gases from both of the gas-tight containers are introduced rapidly into the interior of the air-bag 1, and a skilled person will readily appreciate that there are many ways in which this may be achieved.

As discussed above, if a vehicle occupant is close to the surface 2 from which the air-bag 1 inflates, for instance if the vehicle occupant is leaning forward in his or her seat, then it may be undesirable to inflate the air-bag 1 fully, as this may result in serious injury. Also, if a child seat is mounted in front of the surface 2 from which the air-bag 1 inflates, it may be undesirable to inflate the air-bag 1 fully, as this may cause serious injury to an infant occupying the child seat.

FIG. 1c shows an obstruction 13 which contacts the front of the air-bag 1 during the initial phase of inflation thereof. The obstruction 13 may be a part of the body of a vehicle occupant, or a child seat, as discussed above. It will be appreciated that, due to the presence of the obstruction 13, the distance between the first and second locations 4, 5 to which the strip 3 of material is connected will not become sufficiently great for the strip 3 of material to become taut, since the forward progress of the front of the air-bag 1 is halted by the presence of the obstruction 13. Thus, it will be appreciated that the igniter 9, which is provided in the loop 6 in the strip 3 of material, will not be activated. Following the initial stage of inflation of the air-bag 1, therefore, the air-bag 1 will not inflate any further.

FIG. 1d illustrates the case in which the obstruction 13 is not present. In this case, the air-bag 1 inflates during the initial stage of inflation thereof, and reaches the stage in which the first and second regions 4, 5 of the inner surface of the air-bag 1 to which the strip 3 of material is attached are sufficiently far apart that the strip 3 of material is taut, apart from the loop 6 provided therein, which is held together by the lengths 12 of string.

Referring to FIG. 1e, the air-bag 1 then continues to inflate, so that the lengths of string 12 holding the loop 6 in place are broken, and the strip 3 of material is pulled out of the looped configuration. It will be understood that, at this point, one or both of the cables 10, 11 that extend from the regions 7, 8 of the strip 3 of material to the igniter 9 will be pulled away from the igniter 9, and, as explained above, the igniter 9 will be activated, igniting the combustible gas or gases within the air-bag 1. This will cause the air-bag 1 to inflate rapidly and reach a fully inflated state, which is shown in FIG. 1f.

Thus, it will be understood that, if there is an obstruction in the patch of the air-bag 1, the air-bag 1 will only undergo the first stage of inflation. However, if the initial stage of inflation is unimpeded, the air-bag 1 will subsequently undergo a second stage of inflation, when the igniter 9 is activated, and rapidly reach a fully inflated state.

As discussed above, the strength of the retaining arrangement that maintains the looped configuration of the strip 3 of material determines the force which must be applied across the strip 3 of material for the igniter 9 to be activated. If the air bag 1 meets some resistance during the initial stage of inflation thereof, but does not meet a fixed obstruction, then it may still be desirable for the air bag 1 to undergo the second stage of inflation thereof. A skilled person will readily appreciate how the retaining arrangement may be adjusted so that the air bag 1 will react appropriately in these circumstances.

As an alternative to the above arrangement, two strips 3 of material may be provided, one end of each of which is attached to one of the first and second regions 4, 5 of the inner surface of the air-bag 1, with the other end of each being attached to one of the cables 10, 11. Thus, if the inflation of the air-bag 1 is unimpeded, both of the strips 3 of material will pull on the cables, the igniter 9 being configured so that pulling on a selected one, or on either one, of the cables causes the igniter 9 to activate.

An alternative embodiment of the present invention is shown in FIGS. 3a and 3b. In this embodiment, the strip 3 of material is attached at one end thereof to a region 14 of the interior of the air-bag 1. The other end of the strip 3 of material is attached directly to an igniter 9, which is attached to the inner surface of the air-bag 1, near the surface 2 to which the air-bag 1 is attached. The strip 3 of material may be attached directly to the igniter 9, or may be attached thereto indirectly, for example by way of a pull element such as a short cable (not shown). The igniter 9 is again configured to activate when the strip 3 is pulled therefrom.

It will be appreciated that if an obstruction is placed in the path of the air-bag 1 during the initial phase of expansion thereof, the distance between the region 14 of the inner surface of the air-bag 1 and the igniter 9 will not become sufficiently large for the strip 3 of material to become pulled from the igniter 9, and so following the initial phase of expansion of the air-bag 1 the air-bag 1 will not inflate any further.

However, in the case where the expansion of the air-bag 1 is unimpeded, the expansion of the air-bag 1 will cause the strip 3 of material to be pulled from the igniter 9, as the distance between the region 14 of the interior surface of the air-bag 1 and the igniter 9 becomes greater than the length of the strip 3 of material. At this point, the igniter 9 will active, igniting the combustible gas or gases that have been introduced into the air-bag 1 during the initial phase of inflation thereof, and the air-bag 1 will rapidly inflate to a fully inflated state.

In the embodiments described and depicted thus far, the attachment sites to which the ends of the strip 3 of material are attached are separated from one another in a direction directly away from the surface 2 from which the air-bag 1 expands. This need not, however, be the case, and the attachment sites to which the strip 3 of material is attached may be provided in any suitable locations, for instance on opposite sides of the air-bag 1, so that the air-bag 1 will not inflate fully if the inflation of the air-bag 1 in a width direction is impeded. Indeed, the attachment sites to which the strip 3 of material is attached may be selected so that, upon inflation of the air bag, 1, the distance between the attachment sites may be used to determine that the air-bag 1 has inflated to a sufficient size during the initial inflation phase thereof that it is appropriate for the igniter 9 to be activated, thus inflating the air-bag 1 fully.

It will be appreciated that the present invention provides an improved ignition method. In the above-identified prior art, the inflation of the air-bag 1 to a certain size is detected, this information is passed to a control device, and subsequently an ignition signal is generated for transmission to the igniter. This is a relatively cumbersome method, involving an extra delay, for the signals to pass between the sensors and the control device and between the control device and the igniter, and also includes a greater number of components, and hence entails a greater possibility of failure.

When used in this Specification and Claims, the terms “comprises” and “comprising” and variations thereof mean that the specified features, steps or integers are included. The terms are not to be interpreted to exclude the presence of other features, steps or components

1. A safety arrangement comprising:
an inflatable element;
an inflator to provide a combustible gas to the interior of the inflatable element to inflate the inflatable element at least partially;
a flexible member having first and second portions which are respectively connected to first and second attachment sites, at least one attachment site being on the inflatable element, and
an igniter connected to the inflatable member;
the arrangement being such that on inflation of the inflatable element, the distance between the first and second attachment sites increases, and when the distance between the first and second portions of the flexible member exceeds a predetermined distance, the igniter is ignited, thus igniting the combustible gas within the inflatable element.

2. A safety arrangement according to claim 1, wherein:
the flexible member is arranged so that, prior to inflation of the inflatable element, two regions thereof are adjacent one another, and so that, during inflation of the inflatable element, the two regions there of are separated; and
the igniter is arranged so that separation of the two regions of the flexible member causes activation of the igniter.

3. A safety arrangement according to claim 2, wherein a pull element is connected between one of the two regions and the igniter, and the igniter is arranged so that pulling of the pull element from the igniter causes activation of the igniter.

4. A safety arrangement according to claim 3, wherein two pull elements are provided, connecting respective ones of the two regions with the igniter.

5. A safety arrangement according to claim 2 wherein:
prior to inflation of the inflatable element, the flexible member is configured to contain a loop so that the two regions thereof are adjacent; and
a retaining arrangement is provided to hold the loop in place prior to inflation.

6. A safety arrangement according to claim 5, wherein the retaining arrangement comprises string, wire, sheets or bands.

7. A safety arrangement according to claim 1, comprising two or more flexible members.

8. A safety arrangement according to claim 1, wherein a pair of flexible members are provided, each of which is attached to respective pull elements of the igniter and to respective regions of the inflatable element, and wherein the igniter is arranged so that pulling of at least one of the pull elements from the igniter causes activation of the igniter.

9. A safety arrangement according to claim 1, wherein the or each flexible member is provided substantially within the inflatable element.

10. A safety arrangement according to claim 1 wherein the first and second attachment sites comprise respective portions of the inflatable element.

11. A safety arrangement according to claim 1 wherein one of the attachment sites comprises a portion of the inflatable element, and the other of the connection sites comprises a part of the igniter.

12. A safety arrangement according to claim 1, wherein the igniter is configured to activate upon pulling of part of the flexible member from the igniter.

13. A safety arrangement according to claim 1, wherein the combustible gas comprises a mixture of gases.

14. A method of inflating an inflatable element, the method comprising the steps of:
providing an inflatable element;
providing an inflator for providing a gas to the interior of the inflatable element to inflate the inflatable element at least partially;
providing a flexible member having first and second portions;
connecting the first and second portions to first and second attachment sites, at least one of the attachment sites being on the inflatable element and the arrangement being such that, during a first inflation phase of the inflatable element, the distance between the first and second attachment sites increases;
connecting an igniter to the flexible member generating combustible gas from the inflator to at least partially inflate the inflatable element; and
when the distance between the first and second portions of the flexible member exceeds a predetermined distance, igniting the igniter and thus igniting the combustible gas within the inflatable element.
